(19) United States
(12) Patent Application Publication
(10) Pub. No.: US 2007/0040959 A1
(43) Pub. Date: Feb. 22, 2007

(54) Light guide plate, backlight module and liquid crystal display device using the same

(75) Inventor: Ming-Yi Liao, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/407,178

(22) Filed: Apr. 19, 2006

(30) Foreign Application Priority Data
Aug. 18, 2005 (CN) 200510036733

(51) Int. Cl. G02F 1/1335

(52) U.S. Cl. 349/62

(57) ABSTRACT

A light guide plate includes a light input surface, a first light output surface adjacent to the light input surface, a second light output surface facing in the opposite direction to the first light output surface, and a plurality of pattern dots formed on the second light output surface. The second light output surface has a main portion and a peripheral portion surrounding the main portion. The pattern dots have a distribution density which progressively increases with increasing distance from the light input surface, and a distribution density of pattern dots in the main portion is larger than that of the adjacent pattern dots parallel to the light input surface in the peripheral portion. A two-surface liquid crystal display device using the same light guide plate is also provided. Thus the present light guide plate and liquid crystal display device have good optical performance.

### TECHNICAL FIELD

The present invention relates to a light guide plate, backlight module, and liquid crystal display device using the same, more particularly, to a two-surface liquid crystal display device for use in, for example, a mobile phone or a portable digital assistant (PDA).

### BACKGROUND

The miniaturizing of hand held devices such as mobile phones or portable digital assistant (PDA) have brought successful commercialization of the folded design—a design that allows the liquid display panel of such devices to be folded over the keypad when not in use. Recent development of handheld devices introduced a miniaturized panel placed on the back side of the liquid display panel so as to display information when a foldable device is in a not-in-use state. This product is referred to as a “two-surface” liquid crystal display device.

Typically, the two-surface liquid crystal display device includes a planar backlight module and two liquid crystal display panels. The two liquid crystal display panels are arranged on the two sides of the backlight module. Light is then emitted to the respective liquid crystal display panels using the backlight module.

Referring to FIG. 6, a typical two-surface liquid crystal display device 10 is shown. The liquid crystal display device 10 includes a main liquid crystal display panel 11, a secondary liquid crystal display panel 12, and a backlight module 15. The backlight module 15 includes a light source 13 and a light guide plate 14. The light guide plate 14 includes a light input surface 143 located at a side surface thereof, a first light output surface 141 adjoining the light input surface 143, and a second light output surface 142 opposite to the first emitting surface 141. The light source 13 is positioned adjacent to the light input surface 143. The main and secondary liquid crystal display panel 11 and 12 are arranged on respective sides of the light guide plate 14 such that the main liquid crystal display panel 11 faces the first light output surface 141 of the light guide plate 14 and the secondary liquid crystal display panel 12 faces the second light output surface 142 of the light guide plate 14. The secondary liquid crystal display panel 12 is smaller than that of the main liquid crystal display panel 11.

The light which is incident on the light guide plate 14 from the light source 13 is propagated in the inside of the light guide plate along the two light output surfaces 141 and 142. The light that is reflected on the first light output surface 141 is emitted from the second light output surface 142. Similarly, the light that is reflected on the second light output surface 142 is irradiated from the first light output surface 141. This light is respectively incident on the secondary liquid crystal display panel 12 and the main liquid crystal display panel 11.

To create a uniform intensity of the illumination of the light from the two light output surfaces 141 and 142, the backlight module 15 further includes a plurality of projections (or grooves) 144 formed on at least one of the two light output surfaces 141 and 142 of the light guide plate 14. A distribution density and sizes of the projections (or grooves) 144 increases with increasing distance from the point light source 13.

However, compared to the area of the first light output surface 141 of the light guide plate 14 that faces the main liquid crystal display panel 11 in an opposite manner, the area of the second light output surface 142 of the light guide plate 14 that faces the secondary liquid crystal display panel 12 is substantially smaller. Accordingly, the intensity of the light which is irradiated from the first light output surface 141 of the light guide plate 14, at one portion of the first light output surface 141 that faces a region of the second light output surface 142 that faces the secondary liquid crystal display panel 12, is substantially smaller compared to the intensity of light at a peripheral portion which surrounds this one portion. As a result, an image that is displayed on the main liquid crystal display panel 11 suffers from so-called brightness irregularities wherein the image is substantially darker than the corresponding regions of the first light output surface 141 of the light guide plate 14 that faces the secondary liquid crystal display panel 12.

What is needed, therefore, is a light guide plate, backlight module and liquid crystal display device using the same that overcome the above mentioned disadvantage.

### SUMMARY

A light guide plate according to a preferred embodiment includes a light input surface, a first light output surface, a second light output surface, and a plurality of pattern dots. The first light output surface is adjacent to the light input surface. The second light output surface is opposite to the first light output surface and has a main portion and a peripheral portion surrounding the main portion. Pattern dots are formed on the second light output surface. Each pattern dot has a distribution density which progressively increase with increasing distance from the light input surface, and a distribution density of pattern dots in the main portion is larger than that of the adjacent pattern dots parallel to the light input surface in the peripheral portion.

A backlight module according to a preferred embodiment includes a light guide plate and a light source. The same light guide plate as described in the previous paragraph is employed in this embodiment. The light source is disposed adjacent to the light input surface of the light guide plate.

A liquid crystal display device according to a preferred embodiment includes a main liquid crystal display panel, a secondary liquid crystal display panel and a backlight module. The same backlight module as described in the previous paragraph is employed in this embodiment. The main liquid crystal display panel is arranged to have the main surface thereof face the first light output surface of the light guide plate of the backlight module, the secondary liquid crystal display panel is arranged to have the main surface thereof face the main portion of the second light output surface of the light guide plate of the backlight module. The secondary liquid crystal display panel has a main surface that is smaller than that of the main liquid crystal display panel.

Other advantages and novel features will become more apparent from the following detailed description of the preferred embodiments, when taken in conjunction with the accompanying drawings.

### BRIEF DESCRIPTION OF THE DRAWINGS

Many aspects of the light guide plate and the related backlight module and liquid crystal display device having the same can be better understood with reference to the following drawings. The components in the drawings are not necessarily to scale, the emphasis instead being placed upon clearly illustrating the principles of the present light guide plate and the related backlight module and liquid crystal display device. Moreover, in the drawings, like reference numerals designate corresponding parts throughout the several views.

FIG. 1 is a schematic, cross-sectional view of a liquid crystal display device according to a first preferred embodiment;

FIG. 2 is a schematic, top plan view of a second light output surface of a light guide plate of the liquid crystal display device of FIG. 1;

FIG. 3 is an enlarged view of a circled portion III in FIG. 2;

FIG. 4 is an enlarged view of a circled portion IV in FIG. 2;

FIG. 5 is a schematic, top plan view of a second light output surface of a light guide plate according to a second preferred embodiment; and

FIG. 6 is a schematic, cross-sectional view of a conventional liquid crystal display device.

### DETAILED DESCRIPTION OF THE PREFERRED EMBODIMENTS

Reference will now be made to the drawings to describe preferred embodiments of the present liquid crystal display device, in detail.

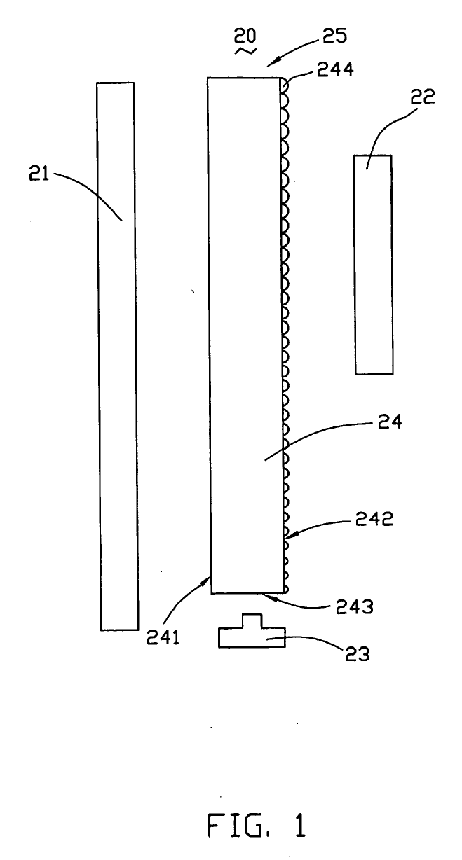

Referring to FIG. 1, a liquid crystal display device 20 in accordance with a first preferred embodiment is shown. The liquid crystal display device 20 includes a main liquid crystal display panel 21, a secondary liquid crystal display panel 22, and a backlight module 25. The backlight module 25 includes a point light source 23 and a light guide plate 24. The light guide plate 24 includes a light input surface 243 located at a side surface thereof, a first light output surface 241 adjoining the light input surface 243, a second light output surface 242 facing in an opposite direction to the first light output surface 241, and a plurality of pattern dots 244 formed on the second light output surface 242. The light source 23 is positioned adjacent to the light input surface 243.

The main and secondary liquid crystal display panels 21 and 22 are arranged at respective sides of the light guide plate 24. The main liquid crystal display panel 21 faces the first light output surface 241 of the light guide plate 24 in an opposed manner, and the secondary liquid crystal display panel 22 faces the second light output surface 242 of the light guide plate 24 in an opposed manner. The main liquid crystal display panel 21 has a main surface. The secondary liquid crystal display panel 22 has a main surface that is smaller than that of the main liquid crystal display panel 21.

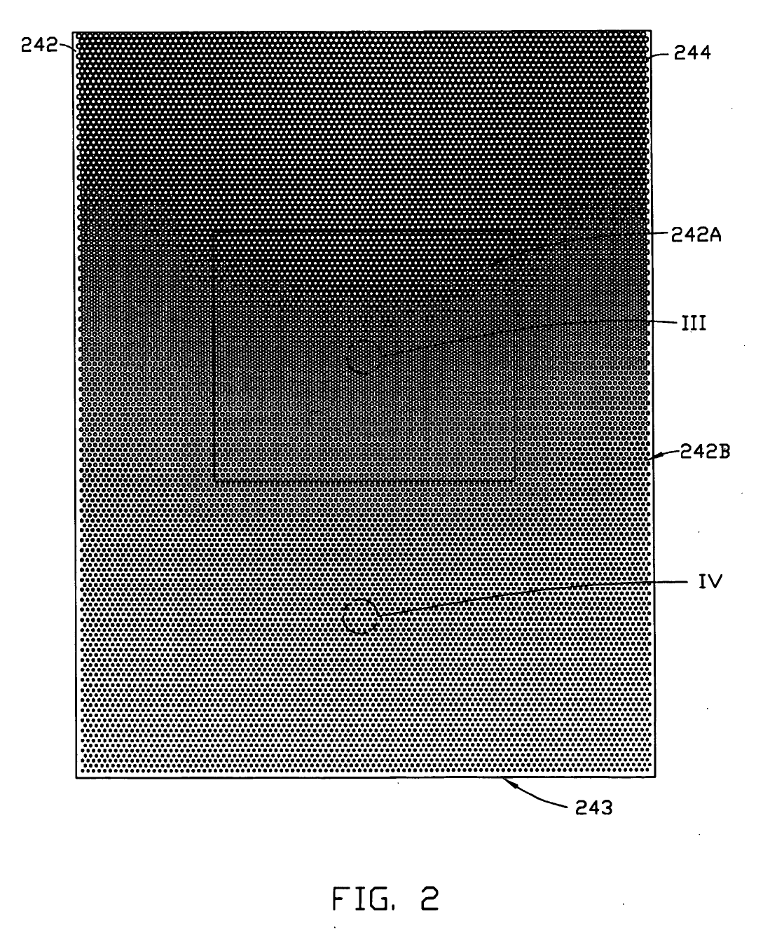

Referring to FIGS. 2 through 4, the second light output surface 242 includes a main portion 242A and a peripheral portion 242B surrounding the main portion 242A. The main portion 242A of the second light output surface 242 of the light guide plate 24 faces the secondary liquid crystal display panel 22. The area of the main portion 242A is the same as the main surface of the secondary liquid crystal display panel 22. A shape of the main portion 242A and the main surface of the secondary liquid crystal display panel 22 are all configured to be rectangular.

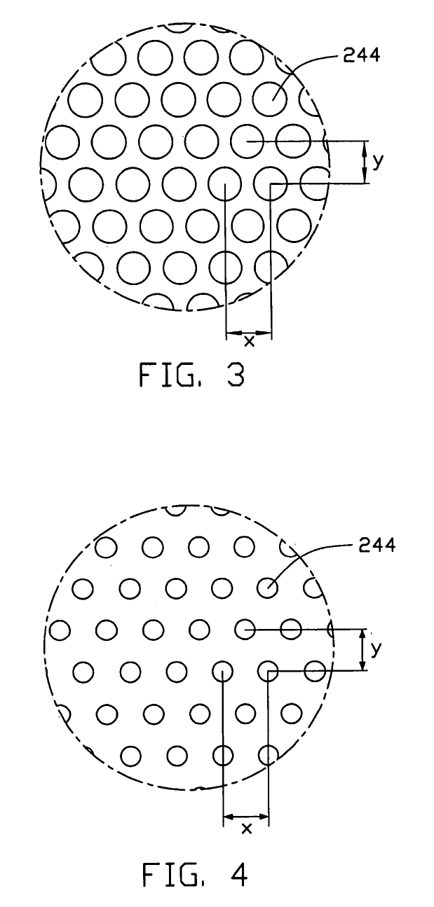

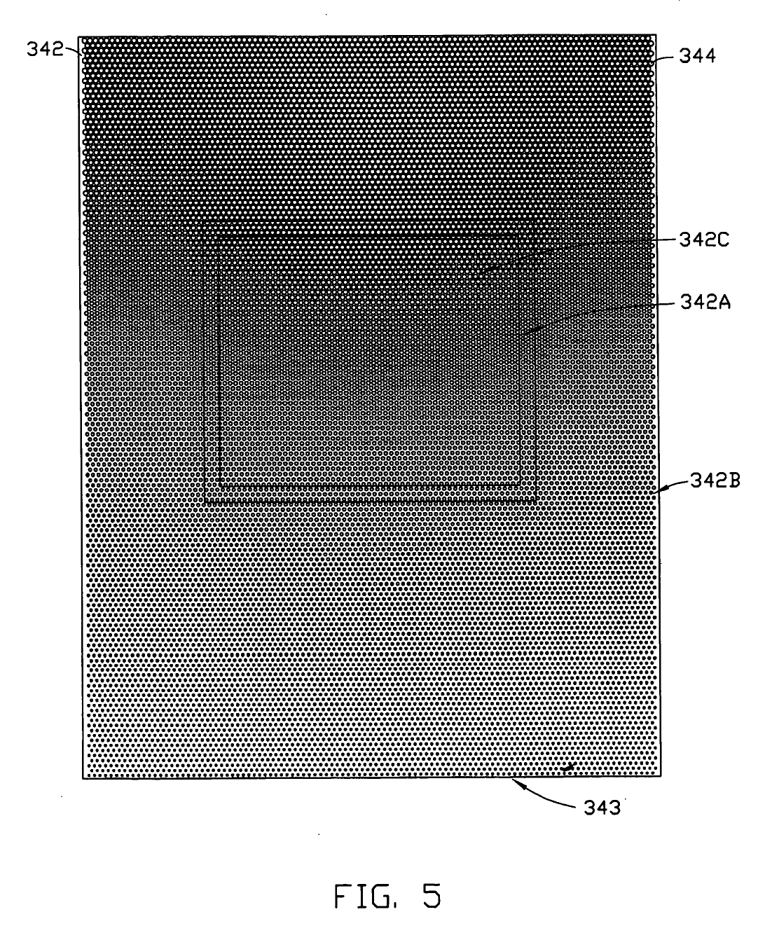

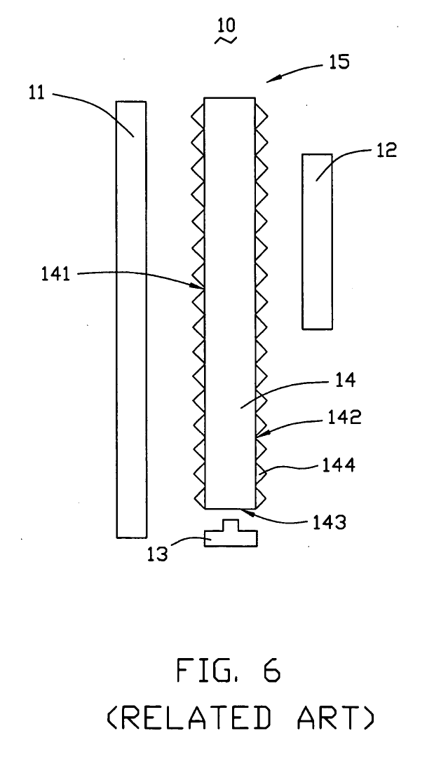

The pattern dots 244 are arranged on the second light output surface 242 in a regular array that defines a plurality of rows parallel to the light input surface 243 and a plurality of columns perpendicular to the light input surface 243. Pattern dots 244 of odd rows and adjacent even rows are respectively positioned in an interlaced manner. Also referring to FIGS. 3 and 4, a distribution density of the pattern dots 244 is defined as following equation: d=π×r²(xxy), wherein d represents the distribution density of the pattern dot 244, r represents a radius of the pattern dots 244, x represents a distance between the two central points of two adjacent pattern dots 244 on the same row, and y represents a distance between two adjacent rows. The distance between the two adjacent rows is also a distance between two adjacent imaginary lines that respectively connects a plurality of central points of pattern dots 244 of the same row.

In the illustrated embodiment, the distance y between the two adjacent rows is configured to be a constant, and the distance x between the two central points of two adjacent pattern dots 244 of the same row is also configured to be a constant. A radius of the pattern dots 244 is configured to be approximately in the range from 0.04 to 1.0 millimeters. A height (or depth) of the pattern dots 244 is configured to be approximately in the range from 10 to 45 millimeters.

A distribution density and size of the pattern dots 244 progressively increases with increasing distance from the light input surface 243. Furthermore, a distribution density of pattern dots 244 in the main portion 242A is larger than that of the adjacent pattern dots 244 parallel to the light input surface 243 in the peripheral portion 242B. The distribution density of the pattern dots 244 of the same row of the peripheral portion 242B of the second light output surface 242 is same. In the same way, the distribution density of the pattern dots 244 of the same row of the main portion 242A of the second light output surface 242 is also same. In illustrated embodiment, the distribution density of pattern dots 244 in the main portion 242A is larger by a factor of 3 to 10 percent than that of the adjacent pattern dots 244 parallel to the light input surface 243 in the peripheral portion 242B.

Due to the distribution density of pattern dots 244 of the main portion 242A of the second light output surface 242 is larger than that of the adjacent pattern dots 244 parallel to the light input surface 243 in the peripheral portion 242B, an intensity of the light which is emitted from the first light output surface 241, at one portion of the first light output surface 241 which faces the secondary liquid crystal display panel 22 is increased. Therefore, a uniformity of light that is emitted from the first light output surface 241 is increased. Furthermore, optical performance of the main liquid crystal display panel 21 is also increased, so as to avoid images having a darker shade corresponding to regions of the first light output surface 241 of the light guide plate 24 that faces the secondary liquid crystal display panel 22.

The array of the pattern dots 244 can be manufactured by printing or chemical etching using a pattern mask. A material of the pattern dot 244 can be selected from a group consisting of printing ink or other suitable modified printing ink. The modified printing ink is formed by uniformly dispersing a plurality of scattering particles into printing ink matrix material.

In the illustrated embodiment, the main and secondary liquid crystal display panels 21 and 22 respectively include a pair of substrates (not shown) and a liquid crystal layer (not shown) sandwiched between the pair of substrate. A material of the substrate can be selected from a group comprising of glass and/or plastics having suitable optical transmissivity. A material of the light guide plate can be selected from a group comprising of polymethyl methacrylate (PMMA), polycarbonate (PC), and other suitable transparent resin materials.

Referring to FIG. 5, a light guide plate 34 in accordance with a second preferred embodiment is shown. The light guide plate 34 includes a light input surface 343, a second light output surface 342 adjoining the light input surface 343, a first light output surface (not shown) facing in an opposite direction to the second light output surface 342, and a plurality of pattern dots 344 formed on the second light output surface 342. The second light output surface 342 has a main portion 342A, a peripheral portion 342B surrounding the main portion 342A, and a projection portion 342C defined in the main portion 342. The pattern dots 344 have a distribution density which progressively increase with increasing distance from the light input surface 343, and a distribution density of pattern dots 344 in the main portion 342A is larger than that of the adjacent pattern dots 344 parallel to the light input surface 343 in the peripheral portion 342B. The light guide plate 34 is the same as the light guide plate 24, except that area of the main portion 342A is larger than that of the main portion 242A of the light guide plate 24 and the area of the projection portion 342C is equal to that of the main portion 242 of the light guide plate 24.

In the first embodiment, the area of the main portion 242A of the second light output surface 242 equals to the area of the secondary liquid crystal display panel 22. This results in visible bright lines or dark lines occurring at the fringes of one portion of the main light output surface 241 that faces the secondary liquid crystal display panel 32 because the light that is irradiated from the second light output surface 242 can be reflected unevenly at adjacent side surfaces of the secondary liquid crystal display panel 22. When the light guide plate 34 employed in the first embodiment for replacing the light guide plate 24 thereof, the secondary liquid crystal display device 22 perpendicularly projects at the projection portion 342C of the second light output surface 342. Because the area of the main portion 342A of the second light output surface 242 is larger than that of the secondary liquid crystal display panel 22, the visible bright lines or dark lines occurring at the fringes of one portion of the main light output surface 241 that faces the secondary liquid crystal display panel 32 can be avoided.

In order to further improve the optical uniformity of the backlight module, the pattern dots of the present light guide plate can be configured to properly change their distribution densities at four corners of the light guide plate for improving the brightness of the four corners thereof, based on the light guide plate 24 of the first embodiment. The distribution density of the pattern dots in the main portion is configured to progressively increase along directions from a center of each row of the main portion toward two ends of the same row of the main portion respectively. In the same way, the distribution density of the pattern dots in the peripheral portion progressively increases along directions from a center of each row toward two ends thereof, respectively.

The light source of the present backlight module can be selected from a group comprising of at least a light emitting diode and a cold cathode fluorescent lamp. In other exemplary embodiments, the backlight module may employ a plurality of light emitting diodes as light sources. In such a case, an intensity of the incident light close to the incident surface is generally non-uniform, and a plurality of dark areas may therefore be formed adjacent the incident surface. In order to solve this problem, a light guide plate of the backlight module further includes a plurality of V-shaped projections formed on the light input surface thereof The V-shaped projections extend outwardly and substantially perpendicular from the light input surface and, thus, toward the light emitting diodes. Each V-shaped projection has a triangular cross-section having a vertex or apex angle that is appropriately in the range from 100 to 120 degrees. A pitch of adjacent V-shaped projections is approximately 0.2 millimeters, and each V-shaped projection's width along the light input surface is also approximately 0.2 millimeters.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A light guide plate comprising:
a light input surface;
a first light output surface adjoining the light input surface;
a second light output surface opposite to the first light output surface, wherein the second light output surface has a main portion and a peripheral portion surrounding the main portion; and
a plurality of pattern dots formed on the second light output surface, wherein the pattern dots have a distribution density that progressively increases with increasing distance from the light input surface, and a distribution density of pattern dot in the main portion is larger than that of the adjacent pattern dots parallel to the light input surface in the peripheral portion.

2. The light guide plate according to claim 1, wherein the distribution density of pattern dots in the main portion is larger by a factor in the range from 3 to 10 percent than that of the adjacent pattern dots parallel to the light input surface in the peripheral portion.

3. The light guide plate according to claim 1, wherein the pattern dots are arranged on the second light output surface in a regular array that defines a plurality of rows parallel to the light input surface and a plurality of columns perpendicular to the light input surface.

4. The light guide plate according to claim 3, wherein the distribution densities of the pattern dots of the same row of the main portion is the same.

5. The light guide plate according to claim 3, wherein the distribution density of the pattern dots in the main portion progressively increases along directions from a center of each row of the main portion toward two ends of the same row of the main portion, respectively.

6. The light guide plate according to claim 3, wherein the distribution density of the pattern dots of the same row of the peripheral portion is the same.

7. The light guide plate according to claim 3, wherein the distribution density of the pattern dots in the peripheral portion progressively increases along directions from a center of each row toward two ends thereof.

8. The light guide plate according to claim 1, wherein a radius of the pattern dots is approximately in the range from 0.04 to 1.0 millimeters.

9. The light guide plate according to claim 1, further comprising a plurality of V-shaped projections regularly arranged on the light input surface thereof.

10. The light guide plate according to claim 1, wherein the first light output surface is plane.

11. The light guide plate according to claim 1, wherein a material of the pattern dot is selected from a group comprising of printing ink or suitable modified printing ink that disperse a plurality of scattering particles into its printing ink matrix material.

12. A backlight module comprising:
a light guide plate having:
a light input surface;
a first light output surface adjoining the light input surface;
a second light output surface opposite to the first light output surface, wherein the second light output surface has a main portion and a peripheral portion surrounding the main portion; and
a plurality of pattern dots formed on the second light output surface, wherein the pattern dots have a distribution density that progressively increases with increasing distance from the light input surface, and a distribution density of pattern dots in the main portion is larger than that of the adjacent pattern dots parallel to the light input surface in the peripheral portion; and
at least one light source disposed adjacent to the light input surface.

13. The backlight module according to claim 12, wherein the light source can be selected from the group comprising light emitting diodes and cold cathode fluorescent lamps.

14. A liquid crystal display device comprising:
a main liquid crystal display panel having a main surface;
a secondary liquid crystal display panel having a main surface that is smaller than the main surface of the main liquid crystal display panel;
a light guide plate having a light input surface, a first light output surface adjoining the light input surface, a second light output surface opposite to the first light output surface, wherein the second light output surface has a main portion and a peripheral portion surrounding the main portion, and a plurality of pattern dots formed on the second light output surface; and
at least one light source disposed adjacent to the light input surface; wherein
the main liquid crystal display panel is arranged to have the main surface thereof face the first light output surface of the light guide plate;
the secondary liquid crystal display panel is arranged to have the main surface thereof face the main portion of the second light output surface of the light guide plate; and
each pattern dot has a distribution density that progressively increases with increasing distance from the light input surface, and a distribution density of pattern dots in the main portion is larger than that of the adjacent pattern dots parallel to the light input surface in the peripheral portion.

15. The liquid crystal display device according to claim 14, wherein the area of the main portion of the second light output surface is larger or equal to that of the secondary liquid crystal display panel.

16. The liquid crystal display device according to claim 14, wherein the pattern dots are arranged on the second light output surface in a regular array that defines a plurality of rows parallel to the light input surface and a plurality of columns perpendicular to the light input surface.

17. The liquid crystal display device according to claim 16, wherein the distribution densities of the pattern dots of the same row of the main portion is the same.

18. The liquid crystal display device according to claim 16, wherein the distribution density of the pattern dots of the same row of the peripheral portion is the same.

19. The liquid crystal display device according to claim 13, wherein a radius of the pattern dots is approximately in the range from 0.04 to 1.0 millimeters.
